(19) United States
(12) Patent Application Publication
(10) Pub. No.: US 2026/0254804 A1
(43) Pub. Date: Aug. 27, 2026

(54) METHOD FOR SUSPENDING A CERTIFICATION TOKEN FOR AUTHENTICATING THE ESTABLISHMENT OF A CONNECTION BETWEEN TWO ITEMS OF COMMUNICATION EQUIPMENT, CORRESPONDING DEVICES AND COMPUTER PROGRAMS

(71) Applicant: Orange, Issy-Les-Moulineaux (FR)

(72) Inventors: Romuald CORBEL, Chatillon Cedex (FR); Emile STEPHAN, Chatillon Cedex (FR); Gaël FROMENTOUX, Chatillon Cedex (FR); Frédéric FIEAU, Chatillon Cedex (FR)

(21) Appl. No.: 18/877,177

(22) PCT Filed: Jun. 19, 2023
(86) PCT No.: PCT/EP2023/066499

§ 371 Date: Dec. 19, 2024

(30) Foreign Application Priority Data
Jun. 22, 2022 (FR) FR2206199

(51) Int. Cl. H04L 9/40

(52) U.S. Cl. CPC H04L 63/0823; H04L 63/0807

(57) ABSTRACT

A method for suspending a certificate provided to an item of equipment in an edge computing environment. Existing authentication solutions are not well suited to the context of edge computing since they cannot meet the demands required to manage this equipment, which may be deployed in distributed infrastructures but which may, above all, be reconfigured, suspended, removed, re-established or even reassigned to another master node depending on the requirements to be met. The method makes it possible, by reusing components that are already present in a communication network, to manage (suspend, cancel the suspension) a certificate the integrity of which cannot be called into question since the trusted third party who issued the certificate is the operator managing the communication network.

### CROSS-REFERENCE TO RELATED APPLICATIONS

This application is filed under 35 U.S.C. § 371 as the U.S. National Phase of Application No. PCT/EP2023/066499 entitled “METHOD FOR SUSPENDING A CERTIFICATION TOKEN FOR AUTHENTICATING THE ESTABLISHMENT OF A CONNECTION BETWEEN TWO ITEMS OF COMMUNICATION EQUIPMENT, CORRESPONDING DEVICES AND COMPUTER PROGRAMS” and filed Jun. 19, 2023, and which claims priority to FR 2206199 filed Jun. 22, 2022, each of which is incorporated by reference in its entirety.

### BACKGROUND

### Field

The field of the development is that of the certification of an item of equipment connected to a communication network. More precisely, the development relates to a solution for managing the suspension of a certificate associated to an item of equipment in an “edge computing” environment.

### Description of the Related Technology

A new phase in the development of “cloud computing” has emerged in the last few years. This new development is known as “edge computing” and involves processing data at the edge of the network, as close as possible to the source of the data.

“Edge computing” minimises bandwidth requirements between equipment, such as sensors, and data processing centres by undertaking the analysis as close as possible to the data sources. This approach requires the mobilisation of resources that may not be permanently connected to a network, such as laptops, smartphones, tablets or sensors. “Edge computing” also plays a key role in content ingestion and delivery solutions. In this respect, many content delivery network (CDN) architectures are based on “edge computing” architectures.

A known implementation of such an “edge computing” architecture is an architecture referred to as Kubernetes.

FIG. 1 shows in a simplified manner the architecture of a node cluster 1 compliant with the Kubernetes solution. The node cluster 1 comprises a first node 10 referred to as the management node, or “Kubernetes master”, and N compute nodes, or “workers nodes”, 11ᵢ, i∈{1, . . . , N}, N being a natural integer.

The management node 10 comprises a controller 101, an API (Application Programming Interface) module 102 and an ETCD database 103 (name of the main Kubernetes database, that stores the system configurations or distributed machine clusters) that consists of a dynamic configuration register for the compute nodes 11_{i.}

A compute node 11ᵢ comprises M containers or “pods” 110ⱼ, j∈{1, . . . , M}, M being a natural integer. Each container 110ⱼ is equipped with resources for executing one or more tasks. When a task is executed, it contributes to implementing a network service or a function, such as a DHCP (Dynamic Host Configuration Protocol) function, for example.

With a view to reducing costs and improving the flexibility of network infrastructures, “edge computing” architectures are most often multi-site architectures in which the nodes constituting the node clusters can be non-co-located. For example, a management node 10 and two compute nodes 11₁, 11₂ of a node cluster 1 are located at a site A, while three other compute nodes 11₃, 11₄, 11₅ are located at a remote site B.

Existing authentication solutions, such as the https (Hyper Text Transfer Protocol Secure) protocol, that is based on the introduction of an encryption layer compliant with the SSL (Secure Socket Layer) or on the introduction of an encryption layer compliant with the TLS (Transport Layer Security) protocol are not well suited to the context of “edge computing”.

The https protocol allows a visitor's item of equipment, such as a personal computer, to verify the identity of a website that the visitor wants to access from their item of equipment.

Thus, the item of equipment verifies the identity of a server hosting the website, using a public authentication certificate of the X509 type issued by a third-party authority, deemed to be reliable, to a server providing a service. Such a certificate guarantees the confidentiality and integrity of the data transmitted by the visitor to the server providing a service.

Such a mode of operation, i.e. verifying the identity of an item of equipment with which a communication session is to be established, cannot meet the needs required to manage the compute nodes. Indeed, such a management is complex because the compute nodes may be deployed in distributed, private or even mobile infrastructures, but above all, they may be reconfigured, suspended, removed, re-established or even reassigned to another node cluster depending on the requirements to be met. Each of these operations may call into question the validity of the certificates associated with the compute nodes.

In addition, the compute nodes correspond, from a protocol point of view, to the visitor's item of equipment described in the example above. It can therefore be seen that applying the https solution to an “edge computing” architecture is not appropriate.

There is therefore a need to propose a solution for managing equipment belonging to an “edge computing” architecture that does not have some or all of the above-mentioned disadvantages.

### SUMMARY

The development partly responds to this need by proposing a method for suspending a first certification token corresponding to a first certificate, said first certification token allowing authenticating the establishment of a connection between an item of equipment connected to at least one communication network and at least one server of a service provider, said first certification token and said first certificate being generated from a hash of a physical address of said item of equipment, a certificate associated with a network address configuration server and at least one network address allocated to said item of equipment by said network address configuration server.

Such a method is particular in that it comprises the following steps implemented by said certificate creation module:
suspending said first certification token triggered by obtaining an item of information relating to a condition for suspending said first certification token,
transmitting, to the domain name server, a request for suspending an association established between the first certificate, the first certification token and at least one domain name.

The solution that is the subject of the present development makes it possible not to revoke a certificate systematically when the item of equipment is reconfigured, suspended, corrupted or, in the case of a mobile item of equipment, when it changes its access network or access technology.

The present solution proposes to suspend a certification token corresponding to a certificate associated with the item of equipment instead of revoking it. It is then no longer necessary to go implement all the steps required for obtaining a new certificate. This also reduces the number of exchanges relating to the management of this certificate for such an item of equipment, which is particularly interesting in a context of “edge computing” where agility is essential.

Such a certificate creation module can be co-located with the configuration server or with the domain name server, in which an association of said certificate with at least one domain name provided by the configuration server is stored.

Finally, knowing that the item of equipment may be allocated a plurality of network addresses, or “address pool”, the first certification token is associated with all or part of this address pool. Similarly, a same item of equipment can have several certificates and corresponding certification tokens at the same time.

Such a certification token makes it possible to verify the authenticity and integrity of the certificate associated with the item of equipment and thus authorise the establishment of a connection with the item of equipment.

The establishment of such a connection corresponds, for example, to the integration of the item of equipment into a Kubernetes architecture as a compute node.

In one embodiment, the method further comprises the steps of:
cancelling the suspension of said first certification token triggered by obtaining an item of information indicating that said condition for suspending said first certification token is no longer satisfied,
transmitting, to said domain name server, a request for cancelling the suspension of said association established between the first certificate, the first certification token and said at least one domain name.

This example is particularly interesting when the item of equipment is a mobile item of equipment, such as a smartphone, in a mobile situation. In such a case, the first certification token associated with the item of equipment is used, for example, when the latter is attached to a home network. When the item of equipment leaves the coverage area of the home network, the first certification token is suspended. When the item of equipment attaches again to the home network, for example when the smartphone user returns home, the suspension of the first certification token can be cancelled, thus allowing the smartphone to access the server of a service provider without having to request a certificate again.

If the item of equipment has a second certificate and therefore a second certification token, when the item of equipment leaves the coverage area of the home network, the first certification token is suspended, and the second certification token, which is intended to be used when the item of equipment is attached, for example, to a fifth-generation or 5G radio network, is used independently by the second network.

As a corollary, when the item of equipment attaches again to the home network, the suspension of the first certification token can be cancelled and the second certification token is suspended.

In another example, the method further comprises the following steps when the condition of suspending said first certification token is accompanied by a request to replace said first certification token:
generating a second certificate associated with said item of equipment and a corresponding second certification token,
transmitting, to said domain name server, a request to associate said second certificate and said second certification token with said domain name previously associated with the first certificate and the corresponding first certification token,
transmitting said second certification token to said item of equipment.

Such an example is of interest when the validity of the certification token is about to expire, but also when the certificate associated with the item of equipment is corrupted or has been hacked. In such a case, the connection established between the item of equipment and the server of the service provider is maintained and the second certification token is transmitted to the item of equipment over this connection, making the operation transparent to a user of the item of equipment. The generation of this second certification token as a replacement for the first certification token activates a specific connection management mechanism such as the monitoring of the use of this second certification token, the purpose of which is to track and examine the exchanges taking place between the item of equipment and the server of the service provider in order to determine whether the connection is corrupt.

This means, for example, slowing down the exchanges initiated by the server over the connection in order to keep it active longer so that it can be observed over a longer period.

Again in this example, the second certification token can also provide restricted access to the resources of the server of a service provider.

Thus, the second certification token contributes to set up a “sandbox” by limiting the access of the item of equipment to certain services or by isolating the traffic linked to this service to or from the item of equipment.

In order to further isolate the traffic linked to the item of equipment, the method further comprises a step of transmitting, to the network address configuration server, a request to provide said equipment with at least one network address pointing to a host machine acting as a fictitious server of the provider.

In this case, the network address provided to the item of equipment is a network address referred to as “black hole”, which does not make it possible to route the traffic to the item of equipment or does not make it possible to transmit the traffic from the item equipment to the server of the service provider, but indicates to a router that this traffic can be routed to another dedicated item of equipment suitable for processing data from/to a potentially corrupted item of equipment, or that this traffic cannot be routed at all.

In another example, said condition for suspending said first certification token belongs to a group comprising:
a request for suspending said first certification token, said suspension request being issued by the item of equipment,
a request for suspending said first certification token, said suspension request being issued by an item of equipment of the network
an expiration of an allocation time of the network address allocated to the item of equipment,
an expiration of a lifetime of the first certification token,
a use conflict in an addressing plan,
an item of information relating to a compromise of the first certification token,
an item of information relating to a hacking of the first certification token.

The development also concerns a certificate creation module adapted to suspend a first certification token corresponding to a first certificate, said first certification token for authenticating the establishment of a connection between an item of equipment connected to at least one communication network and at least one server of a service provider, said first certification token and said first certificate being generated by said certificate creation module from a hash of a physical address of said item of equipment, a certificate associated with a network address configuration server and at least one network address allocated to said item of equipment by said network address configuration server, said certificate creation module comprising at least one processor configured to:
suspend said first certification token after obtaining an item of information relating to a condition for suspending said first certification token,
transmit, to the domain name server, a request for suspending an association established between the first certificate, the first certification token and at least one domain name.

The development also relates to a network address configuration server comprising at least one certificate creation module adapted to suspend a first certification token corresponding to a first certificate, said first certification token for authenticating the establishment of a connection between an item of equipment connected to at least one communication network and at least one server of a service provider, said first certification token and said first certificate being generated by said certificate creation module from a hash of a physical address of said item of equipment, a certificate associated with said network address configuration server and at least one network address allocated to said item of equipment by said network address configuration server, said certificate creation module comprising at least one processor configured to:
suspend said first certification token after obtaining an item of information relating to a condition for suspending said first certification token,
transmit, to the domain name server, a request for suspending an association established between the first certificate, the first certification token and at least one domain name.

The development finally relates to a computer program product comprising program code instructions for implementing the method as described previously, when it is executed by a processor.

The development also relates to a computer-readable storage medium on which is saved a computer program comprising program code instructions for implementing the steps of the method according to the development as described above.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the method of the above-mentioned development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1: this figure shows in a simplified manner the architecture of a node cluster 1 compliant with the Kubernetes solution,

FIG. 2: this figure shows a system in which the present development can be implemented,

FIG. 3: this figure shows the various stages implemented during execution of the methods that are the subject of the present development, leading to obtaining the certification token within the system of FIG. 2,

FIG. 4: this figure shows the sequence of steps of the methods relating to the use of the certification token CNT by an item of equipment belonging to the system of FIG. 2,

FIG. 5: this figure shows the various stages implemented by the different items of equipment making up the system described with reference to FIG. 2 in a first embodiment of the method for suspending a certification token according to the development,

FIG. 6: this figure shows the various stages implemented by the different items of equipment making up the system described with reference to FIG. 2 in a second embodiment of the method for suspending a certification token according to the development,

FIG. 7: this figure shows the various stages implemented by the different items of equipment making up the system described with reference to FIG. 2 in a third embodiment of the method for suspending a certification token according to the development,

FIG. 8: this figure shows an item of equipment capable of implementing the method for the authenticated establishment of a connection between an item of equipment connected to at least one communication network and a server of a service provider that is the subject of the present development,

FIG. 9: this figure shows a creation module capable of implementing the various methods that are the subject of the present development.

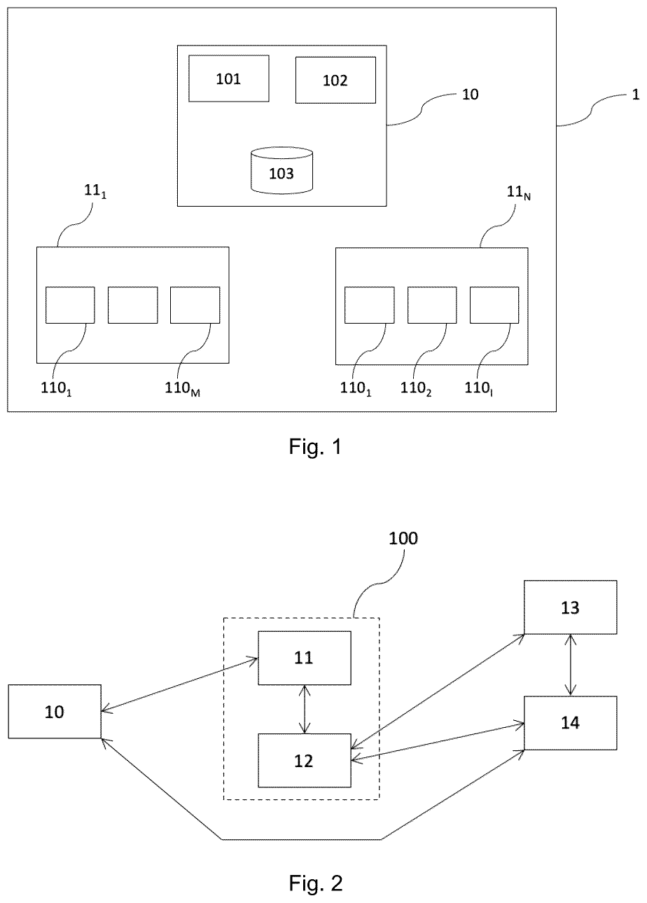

### DETAILED DESCRIPTION OF CERTAIN ILLUSTRATIVE EMBODIMENTS

The general principle of the development relates to managing a certificate, notably, but not exclusively, for an item of equipment located in an “edge computing” environment during operation of said item of equipment. The development provides a mechanism for suspending a certification token corresponding to a certificate associated with said item of equipment. This suspension mechanism makes it possible to avoid having to revoke a certificate associated with the item of equipment temporarily, for example because the item of equipment is in a mobile situation, or because it has been reconfigured, or because time is needed to check for suspected corruption, etc.

Such a solution also has the advantage of being fast, which makes it particularly interesting for architectures requiring frequent dynamic configurations. Indeed, this also reduces the number of exchanges and the amount of processes relating to the management of this certificate for such an item of equipment, which is particularly interesting in a context of “edge computing” where agility is essential.

In relation to FIG. 2, a system in which the present solution may be implemented is now presented.

Such a system comprises at least one item of equipment 10 connected to at least one communication network (not shown in the figures), at least one network address configuration server 11, such as a DHCP (Dynamic Hosts Configuration Protocol) server, at least one certificate creation module 12, at least one domain name server 13, such as a DNS server, and at least one server of a service provider 14, which may or may not be independent of the communication network operator.

The item of equipment 10 may be a mobile terminal as well as a server, a node or a container according to the Kubernetes solution, or even a sensor. It may also be a virtualised item of equipment.

In one embodiment, the configuration server 11 and the certificate creation module 12 can be co-located in the same item of equipment 100 as shown in FIG. 2. In another embodiment, the certificate creation module 12 may be co-located with the domain name server 13 or integrated into it. In yet another embodiment, the certificate creation module 12 may be physically distinct from the configuration server 11 and the domain name server 13.

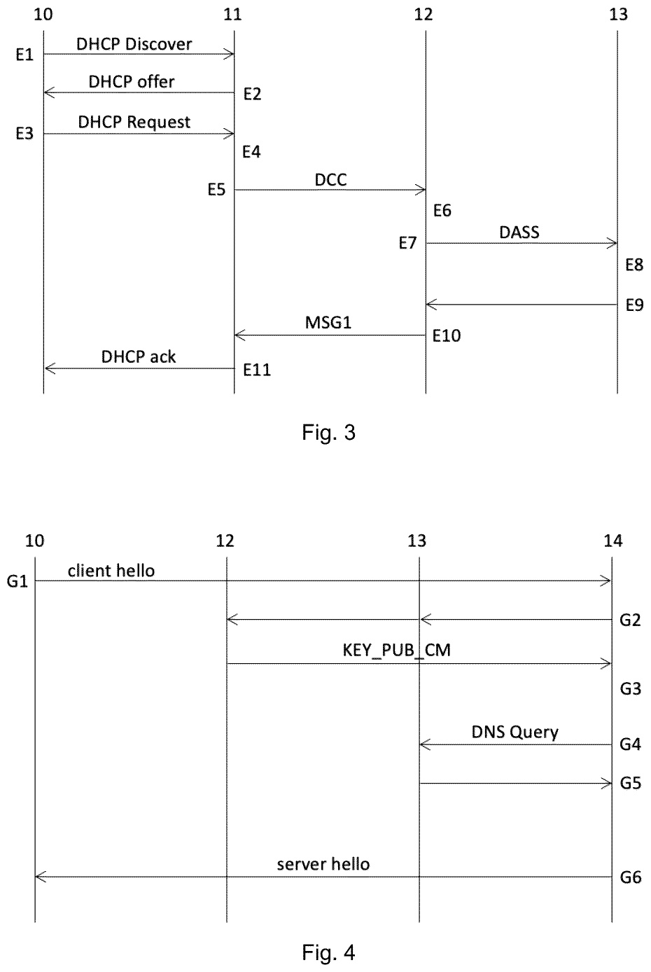

A first part of the sequence of procedures leading to the obtaining of such a certification token and then the procedure for suspending the certification token which is the subject of the development are now described with reference to the system described in FIG. 2. The various steps implemented when executing the methods leading to the obtaining of the certification token within the system previously described are shown in the form of a diagram in FIG. 3.

In a step E1, the item of equipment 10 seeks to connect to a communication network. To this end, the item of equipment 10 sends a DHCP Discover query to the configuration server 11 so that the latter allocates to it one or more network addresses, such as IPv4 or IPv6 addresses.

In a step E2, upon receipt of the Discover DHCP request transmitted by the item of equipment 10, the configuration server 11 proposes, in a standard manner, one or more network addresses to the item of equipment 10 by transmitting a message of the DHCP offer type.

In another example, the configuration server 11 can implement an ACME-STAR delegation method or a “Delegated Credentials” method upon receipt of the Discover DHCP query transmitted by the item of equipment 10. These methods are described in the document referenced Acme-Star RFC 8739 published by the IETF.

The delegated item of equipment 10 can thus receive, in this case in a message of the DHCP offer type, a possibly hashed temporary certificate calculated based on a private key of the delegating configuration server 11.

In a step E3, the item of equipment 10 validates the network address allocation proposal received during step E2 and transmits, to the configuration server 11, a DHCP Request query validating network addresses from among those proposed and comprising parameters relating to the creation of a certificate. Such parameters comprise, amongst others: a public key PUB_KEY_CPE of the item of equipment 10, a hash HASH_CPE of a physical address of the item of equipment 10, such as a MAC (Medium Access Control) address, and a parameter TYP_HASH on how the hash HASH_CPE is calculated. These various parameters can be transmitted in the form of a certificate that can be hashed.

Upon receipt of the DHCP Request query, in a step E4, the configuration server 11 processes the information relating to the allocation of network addresses comprised in this query in a standard manner. When this DHCP Request query is processed, the configuration server 11 detecting the presence of parameters relating to the creation of a certificate in a field of the DHCP Request query, that is the public key PUB_KEY_CPE, the hash HASH_CPE or the parameter TYP_HASH, extracts this information and generates a request for creating a DCC certificate associated with the item of equipment 10.

The request for creating a DCC certificate comprises: the public key PUB_KEY_CPE of the item of equipment 10, the hash HASH_CPE of a physical address of the item of equipment 10, a certificate CertDHCP associated with the configuration server 11, at least one network address IP_CPE allocated to said item of equipment 10 by the configuration server 11 during step E4 (or a pool of network addresses POOL_IP_CPE allocated to the item of equipment 10), and finally the parameter TYP_HASH on how the hash HASH_CPE is calculated. The request for creating a DCC certificate may also comprise a domain name, for example “CNT.example.com”, with which the certificate is intended to be associated.

In a step E5, the configuration server transmits the request for creating a DCC certificate to the certificate creation module 12.

Upon receipt of the request for creating a certificate associated with the item of equipment 10, the certificate creation module 12 generates, during a step E6, a certificate CERT_CPE associated with the item of equipment 10 from the information comprised in the creation request DCC.

Such a certificate CERT_CPE corresponds to a network address allocated to the item of equipment 10. Thus, the certificate creation module 12 creates as many certificates CERT_CPE associated with the item of equipment 10 as it has network addresses. In another embodiment, the certificate creation module 12 creates a single certificate CERT_CPE associated with the item of equipment 10 that applies to the network address pool POOL_IP_CPE allocated to the item of equipment 10. Such a certificate CERT_CPE includes the values of the physical address of the item of equipment 10 and of one or more network addresses chosen during step E3 by the item of equipment 10, in fields of the certificate CERT_CPE such as the Common Name (CN) or SAN fields, for example.

The certificate creation module 12 also generates a certification token CNT (Certificate Network Token) corresponding to the certificate CERT_CPE associated with the connectivity of the item of equipment 10 to the network of 11. Such a certification token CNT is a compact form of the certificate CERT_CPE associated with the item of equipment 10. More particularly, this certification token CNT comprises, amongst others, information relating to the hash HASH_CPE of the physical address of the item of equipment 10, the hash HASH_CERT_CPE of the certificate CERT_CPE associated with the item of equipment 10, and an identifier CN_CM of the certificate creation module 12.

It is this certification token CNT that will be used by the item of equipment 10 in all cases where the latter needs to provide authentication material to access a service. This certification token CNT being is a compact form of the certificate CERT_CPE associated with the item of equipment 10, it can be introduced into many existing messages without increasing the payload of the latter in a detrimental manner. Thus, implementing the solution that is the object of the present development does not impose too heavy a load in a communication network.

In a step E7, the certificate creation module 12 transmits a request DAss for associating the certificate CERT_CPE associated with the item of equipment 10 thus generated with the domain name “CNT.example.com” with which the certificate CERT_CPE is intended to be associated to the domain name server 13.

Such an association request DAss comprises: the certificate CERT_CPE associated with the item of equipment 10, the corresponding certification token CNT, a hash HASH_CNT of the certification token CNT and a parameter TYP_HASH_CNT on how the hash HASH_CNT is calculated. In one embodiment, the parameter TYP_HASH_CNT on how the hash HASH_CNT is calculated may comprise a public key of the certificate creation module 12.

In a step E8, the domain name server 12 stores all the information comprised in the association request DAss in a table and associates it with the “CNT.example.com” domain name.

Once the association between all the information comprised in the association request DAss and the domain name has been performed, the domain name server 13 informs the certificate creation module 12 in a step E9.

In turn, the certificate creation module 12 informs the configuration server 11 of the creation of the certificate CERT_CPE associated with the item of equipment 10 in a step E10. To do this, the certificate creation module 12 transmits to the configuration server 11 a message MSG1 comprising the corresponding certification token CNT, the hash HASH_CNT of the certification token CNT and the parameter TYP_HASH_CNT on how the hash HASH_CNT is calculated.

Finally, the configuration server 11 sends, in a step E11, a message acknowledging a network address assignment DHCP ack. In an existing field of this message DHCP ack, the item of equipment 10 adds the corresponding certification token CNT, the hash HASH_CNT of the certification token CNT and the parameter TYP_HASH_CNT on how the hash HASH_CNT is calculated.

At the end of step E11, the item of equipment 10 thus has a certification token CNT that will be used by the item of equipment 10 in all cases where the latter needs to provide authentication material to access a service. It will be noted that the item of equipment 10 is not in possession of its certificate CERT_CPE and does not know the domain name “CNT.example.com” associated with its certificate CERT_CPE. These two items of information are only stored in the domain name server 12.

Now that the item of equipment 10 has a certificate, it can establish a connection with a server of a service provider 14. FIG. 4 shows the sequence of steps in the methods relating to the use of the CNT certification token by equipment 10.

In a step G1, the item of equipment 10 wanting to establish a connection with the server of a service provider 14 transmits to the latter a TLS client Hello message. In an existing field of this TLS client Hello message, the item of equipment 10 adds the certification token CNT, the hash HASH_CNT of the certification token CNT and the parameter TYP_HASH_CNT on how the hash HASH_CNT is calculated. In practice, the certification token CNT can be carried by any secure exchange protocol such as the QUIC protocol, in a field of any application protocol such as HTTP carried below any combination of protocols guaranteeing the integrity of the exchange, but also in an OAM (iOAM) field described in https://datatracker.ietf.org/doc/html/draft-ietf-ippm-ioam-data-17.txt

In a step G2, the server of a service provider 14 obtains the public key PUB_KEY_CM of the certificate creation module 12. The public key PUB_KEY_CM is, for example, a public field of the X509 certificate of the certificate creation module 12 obtained, after step G1 or beforehand, for example when a secure tunnel is established between the server of a service provider 14 and the certificate creation module 12, or pre-recorded in the server.

Using the public key PUB_KEY_CM of the certificate creation module 12, the server of a service provider 14, in a step G3, verifies the authenticity of the certification token CNT using the public key PUB_KEY_CM of the certificate creation module 12 and the hash HASH_CNT of the certification token CNT and information TYP_HASH_CNT on how the hash HASH_CNT is calculated.

Once this verification has been performed, the server of a service provider 14 asks, in a step G4, the domain name server to provide it with the certificate CERT_CPE associated with the certification token CNT that it has just verified. To do this, the server of a service provider 14 transmits a DNS Query message comprising, in an existing field, the certification token CNT.

In a step G5, the domain name server 13 returns the certificate CERT_CPE corresponding to the certification token CNT received.

In a step G6, the server of a service provider 14 then verifies that the certificate CERT_CPE corresponds to the network address(es) supplied in the TLS client Hello message, knowing that such a certificate CERT_CPE is delivered for one or more network addresses.

Once the item of equipment 10 has been authenticated, the server of a service provider 14 sends a Server Hello message to the item of equipment 10, thereby finalising the establishment of the connection between the latter and the server of a service provider 14 in a step G6.

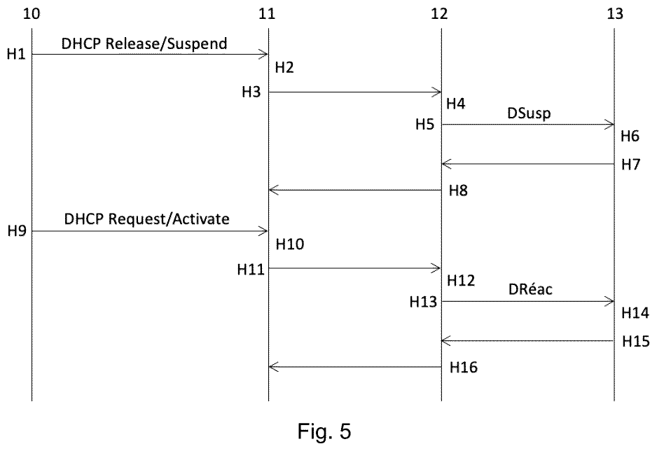

FIG. 5 shows the various steps implemented by the different items of equipment making up the system described with reference to FIG. 2 in a first embodiment of the method for suspending a certification token CNT associated with item of equipment 10.

This method for suspending may or may not be implemented following the execution of step G6, during which a connection is established between the item of equipment 10 and the server of a service provider 14.

In a step H1, the item of equipment 10 transmits, to the configuration server 11, a message requesting the release of the network address(es) allocated to it.

The sending of such a message to the configuration server 11 can be triggered when the item of equipment 10 leaves the coverage area of a first access node, such as a Wi-Fi access node, to attach to a second access node such as a base station. Such a change of access network requires the release of the network address allocated to the item of equipment 10, leading to the suspension of the certification token associated with the item of equipment 10 which has been generated using this network address.

In a first example, such a message is a message of the DHCP Release type comprising the certification token CNT, the hash HASH_CNT of the certification token CNT and the parameter TYP_HASH_CNT on how the hash HASH_CNT is calculated.

In a second example, the item of equipment 10 transmits a new type of message, known as DHCP Suspend. Such a DHCP Suspend message also comprises the corresponding certification token CNT, the hash HASH_CNT of the certification token CNT and the parameter TYP_HASH_CNT on how the hash HASH_CNT is calculated.

Upon receipt of the DHCP Release or DHCP Suspend message, in a step H2, the configuration server 11 processes the information relating to the release of the network addresses comprised in this query in a standard manner.

When processing the DHCP Release message, the configuration server 11 detects the presence of parameters relating to the certificate CERT_CPE in a field of the message, i.e. the corresponding certification token CNT, the hash HASH_CNT of the certification token CNT and the parameter TYP_HASH_CNT on how the hash HASH_CNT is calculated, extracts this information and generates a request to suspend the certification token CNT associated with the item of equipment 10 and the certificate CERT_CPE.

When processing the DHCP Suspend message, the very nature of the message indicates to the configuration server 11 that it must extract the parameters relating to the certificate CERT_CPE included in a field of the DHCP Suspend message, i.e. the corresponding certification token CNT, the hash HASH_CNT of the certification token CNT and the parameter TYP_HASH_CNT on how the HASH_CNT hash is calculated, and generate a request to suspend the certification token CNT associated with the item of equipment 10 and the certificate CERT_CPE.

In another mode, the suspension of the certification token CNT associated with the item of equipment 10 and the certificate CERT_CPE is triggered after the detection of an inactivity of the item of equipment 10 by the network.

The request to suspend the certification token CNT comprises: the corresponding certification token CNT, the hash HASH_CNT of the certification token CNT, the parameter TYP_HASH_CNT on how the hash HASH_CNT is calculated and the certificate CertDHCP associated with the configuration server 11. The request to suspend the certification token CNT may also comprise the domain name, for example “CNT.example.com”, with which the certificate CERT_CPE was associated during step E8.

In a step H3, the configuration server 11 transmits the request to suspend the certification token CNT to the certificate creation module 12.

Upon receipt of the request to suspend the certification token CNT, the certificate creation module 12 optionally verifies, in a step H4, the authenticity of the certification token CNT by means of the certificate CertDHCP associated with the configuration server 11.

Once this verification has been performed, the certificate creation module 12 transmits, in a step H5, a request to suspend Dsusp the association of the certificate CERT_CPE associated with the item of equipment 10 with the domain name “CNT.example.com” with which the certificate CERT_CPE was associated during step E8 to the domain name server 13.

Such a suspension request DSusp comprises: the corresponding certification token CNT, the certificate CERT_CPE and the public key PUB_KEY_CM from the certificate creation module 12.

At the same time, the creation module 12 stores in a database that the certificate CERT_CPE and the corresponding certification token CNT are both suspended.

In a step H6, the domain name server 13 extracts all the information included in the suspension request DSusp and suspends the association established between, on one hand, the certificate CERT_CPE and the corresponding certification token CNT and, on the other hand, the domain name “CNT.example.com”.

Once the association between the certificate CERT_CPE and the corresponding certification token CNT and the domain name has been suspended, the domain name server 13 informs the certificate creation module 12 in a step H7.

In turn, the certificate creation module 12 informs the configuration server 11 of the suspension of the association between the certificate CERT_CPE and the corresponding certification token CNT and the domain name in a step H8.

At the end of step H8, the item of equipment 10 wishing to establish a connection with the server of a service provider 14 transmits the latter a standard client Hello TLS message, i.e. one which does not include a certification token CNT since it has been suspended.

As the server of a service provider 14 cannot find a certification token CNT in the Hello TLS message, it cannot check the validity of any certificate relating to the item of equipment 10.

The server of a service provider 14 then sends a Server Hello message to the item of equipment 10 indicating that the certificate associated with the item of equipment 10 is not valid and that a connection cannot be established with the item of equipment 10.

These exchanges of standard client Hello TLS and Server Hello messages between the item of equipment 10 and the server 14 are not shown in FIG. 5.

When the item of equipment 10 needs to cancel the suspension of the certification token CNT, for example when it reattaches to the Wi-Fi access node of the first access network, it transmits in step H9, to the configuration server 11, a message requesting the allocation of one or more network addresses.

In a first example, such a message is a message of the DHCP Request type comprising the certification token CNT suspended during step H6, the hash HASH_CNT of the certification token CNT and the parameter TYP_HASH_CNT on how the hash HASH_CNT is calculated.

In a second example, the item of equipment 10 transmits a new type of message, known as DHCP Activate. Such a DHCP Activate message also comprises the corresponding certification token CNT, the hash HASH_CNT of the certification token CNT and the parameter TYP_HASH_CNT on how the hash HASH_CNT is calculated.

Upon receipt of the DHCP request or DHCP Activate message, in a step H10, the configuration server 11 processes the information relating to the request for allocating the network addresses comprised in this query in a standard manner.

When processing the DHCP Request message, the configuration server 11 detecting the presence of parameters relating to the certificate CERT_CPE in a field of the message, i.e. the corresponding certification token CNT, the hash HASH_CNT of the certification token CNT and the parameter TYP_HASH_CNT on how the hash HASH_CNT is calculated, extracts this information and generates a request to cancel the suspension of the certification token CNT associated with the item of equipment 10 and the certificate CERT_CPE.

When processing the DHCP Activate message, the very nature of the message indicates to the configuration server 11 that it must extract the parameters relating to the certificate CERT_CPE included in a field of the DHCP Activate message, i.e. the corresponding certification token CNT, the hash HASH_CNT of the certification token CNT and the parameter TYP_HASH_CNT on how the HASH_CNT hash is calculated, and generate a request to cancel the suspension of the certification token CNT associated with the item of equipment 10 and the certificate CERT_CPE.

The request to cancel the suspension of the certification token CNT comprises: the corresponding certification token CNT, the hash HASH_CNT of the certification token CNT, the parameter TYP_HASH_CNT on how the hash HASH_CNT is calculated and the certificate CertDHCP associated with the configuration server 11. The request to cancel the suspension of the certification token CNT may also comprise the domain name, for example “CNT.example.com”, with which the certificate CERT_CPE was associated during step E8.

In a step H11, the configuration server 11 transmits the request to cancel the suspension of the certification token CNT to the certificate creation module 12.

Upon receipt of the request to cancel the suspension of the certification token CNT, the certificate creation module 12 optionally verifies, in a step H12, the authenticity of the certification token CNT by means of the certificate CertDHCP associated with the configuration server 11.

Once this verification has been performed, the certificate creation module 12 transmits, in a step H13, a request to cancel the suspension DRéac of the association of the certificate CERT_CPE associated with the item of equipment 10 with the domain name “CNT.example.com” with which the certificate CERT_CPE was associated during step E8 to the domain name server 13.

Such a request to cancel the suspension DRéac comprises: the corresponding certification token CNT, the certificate CERT_CPE and the public key PUB_KEY_CM from the certificate creation module 12.

At the same time, the creation module 12 stores in a database that the suspension of the certificate CERT_CPE and the corresponding certification token CNT is cancelled.

In a step H14, the domain name server 13 extracts all the information included in the request to cancel the suspension DRéac and re-establishes the association between, on one hand, the certificate CERT_CPE and the corresponding certification token CNT and, on the other hand, the domain name “CNT.example.com”.

Once the association between the certificate CERT_CPE and the corresponding certification token CNT and the domain name has been re-established, the domain name server 13 informs the certificate creation module 12 in a step H15.

In turn, the certificate creation module 12 informs the configuration server 11 of the re-establishment of the association between the certificate CERT_CPE and the corresponding certification token CNT and the domain name in a step H16.

At the end of step H16, the item of equipment 10 wishing to establish a connection with the server of a service provider 14 again implements steps G1 to G6 described above.

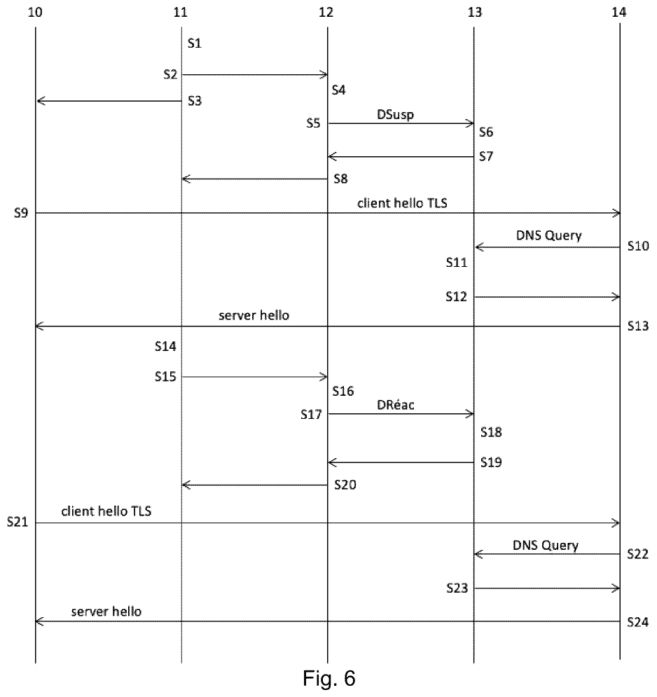

FIG. 6 shows the various steps implemented by the different items of equipment making up the system described with reference to FIG. 2 in a second embodiment of the method for suspending a certification token CNT associated with item of equipment 10.

This method for suspending may or may not be implemented following the execution of step G6, during which a connection is established between the item of equipment 10 and the server of a service provider 14.

In a step S1, the expiration of a lifetime associated with one or more network addresses allocated to the item of equipment 10 triggers the release of these network addresses by the configuration server 11. In another example, the configuration server 11 receives a request to release the network addresses allocated to the item of equipment 10 following a decision by the network operator.

In a step S2, the configuration server 11 transmits a request to suspend the certification token CNT to the certificate creation module 12. Such a suspension request includes the certification token CNT and a code indicating the reasons for this suspension request.

In parallel to step S2, the configuration server 11 transmits a message DHCP NACK to the item of equipment 10 in a step S3. Such a message DHCP NACK indicates to the item of equipment 10 that it is no longer authorised to use the network addresses allocated to it. As the message DHCP NACK also includes the certification token CNT, the item of equipment 10 also understands that it is no longer authorised to use this certification token CNT.

Upon receipt of the request to suspend the certification token CNT, the certificate creation module 12 optionally verifies, in a step S4, the authenticity of the certification token CNT by means of the certificate CertDHCP associated with the configuration server 11.

Once this verification has been performed, the certificate creation module 12 transmits, in a step S5, a request to suspend DSusp the association of the certificate CERT_CPE associated with the item of equipment 10 with the domain name “CNT.example.com” with which the certificate CERT_CPE was associated during step E8 to the domain name server 13.

Such a suspension request DSusp comprises: the corresponding certification token CNT, the certificate CERT_CPE and the public key PUB_KEY_CM from the certificate creation module 12. Such a suspension request also includes the code indicating the reasons for this suspension request.

At the same time, the creation module 12 stores in a database that the certificate CERT_CPE and the corresponding certification token CNT are suspended.

In a step S6, the domain name server 13 extracts all the information included in the suspension request DSusp and suspends the association of the certificate CERT_CPE and the corresponding certification token CNT with the domain name “CNT.example.com”.

Once the association between the certificate CERT_CPE and the corresponding certification token CNT and the domain name has been suspended, the domain name server 13 informs the certificate creation module 12 in a step S7.

In turn, the certificate creation module 12 informs the configuration server 11 of the suspension of the association between the certificate CERT_CPE and the corresponding certification token CNT and the domain name in a step S8.

At the end of step S8, the item of equipment 10 wishing to establish a connection with the server of a service provider 14 transmits the latter a client Hello message that includes a certification token CNT in a step S9.

Upon receipt of this Hello TLS client message, the server of a service provider 14 transmits a message of the DNS Query type including the certification token CNT to the domain name server 13 in a step S10.

The domain name server 13 then checks, during a step S11, the validity of the certification token CNT and sends back, during a step S12, a message indicating that the certification token CNT is no longer valid. The message sent back also includes the code indicating the reasons for this suspension.

The server of a service provider 14 finally transmits, in a step S13, a Server Hello message to the item of equipment 10 indicating that the certificate associated with the item of equipment 10 is not valid and that a connection cannot be established with the item of equipment 10, indicating the reasons for this suspension.

In a step S14, the configuration server 11 receives a request to cancel the suspension of the certification token CNT associated with the item of equipment 10, for example following a decision by the network operator.

In a step S15, the configuration server 11 transmits a request to cancel the suspension of the certification token CNT to the certificate creation module 12. Such a request to cancel the suspension includes the certification token CNT.

Upon receipt of the request to cancel the suspension of the certification token CNT, the certificate creation module 12 optionally verifies, in a step S16, the authenticity of the certification token CNT by means of the certificate CertDHCP associated with the configuration server 11.

Once this verification has been performed, the certificate creation module 12 transmits, in a step S17, a request to cancel the suspension DRéac of the association of the certificate CERT_CPE associated with the item of equipment 10 with the domain name “CNT.example.com” with which the certificate CERT_CPE was associated during step E8 to the domain name server 13.

Such a request to cancel the suspension DRéac includes the corresponding certification token CNT, the certificate CERT_CPE and the public key PUB_KEY_CM from the certificate creation module 12.

At the same time, the creation module 12 stores in a database that the suspension of the certificate CERT_CPE and the corresponding certification token CNT is cancelled.

In a step S18, the domain name server 13 extracts all the information included in the request to cancel the suspension DRéac and re-establishes the association between, on one hand, the certificate CERT_CPE and the corresponding certification token CNT and, on the other hand, the domain name “CNT.example.com”.

Once the association between, on one hand, the certificate CERT_CPE and the corresponding certification token CNT and, on the other hand, the domain name has been re-established, the domain name server 12 informs the certificate creation module 12 in a step S19.

In turn, the certificate creation module 12 informs the configuration server 11 of the suspension cancelling of the association between the certificate CERT_CPE and the corresponding certification token CNT and the domain name in a step S20.

At the end of step S20, the item of equipment 10 wishing to establish a connection with the server of a service provider 14 transmits the latter a client Hello message that includes a certification token CNT in a step S21.

Upon receipt of this Hello TLS client message, the server of a service provider 14 transmits a message of the DNS Query type including the certification token CNT to the domain name server 13 in a step S22.

The domain name server 13 then checks the validity of the certification token CNT and sends back, during a step S23, a message indicating that the certification token CNT is valid.

The server of a service provider 14 finally transmits, in a step S24, a Server Hello message to the item of equipment 10, thus establishing a connection with the item of equipment 10.

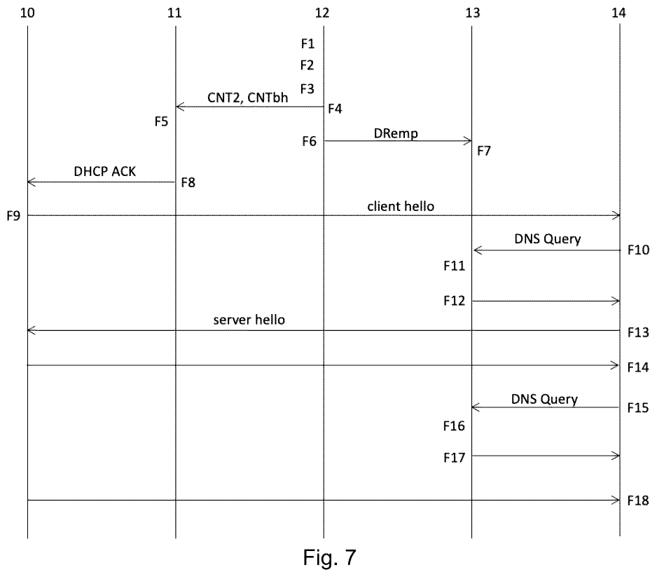

FIG. 7 shows the various steps implemented by the different items of equipment making up the system described with reference to FIG. 2 in a third embodiment of the method for suspending a certification token CNT associated with item of equipment 10.

This method for suspending is implemented following the execution of step G6, during which a connection is established between the item of equipment 10 and the server of a service provider 14.

In a step F1, the creation module 12 receives a request from the network operator to replace a first certification token CNT1 associated with the item of equipment 10. Such a replacement request may be sent for several reasons: the first certification token CNT1 is a temporary certification token that needs to be replaced as it is about to expire, the first certification token CNT1 is corrupted or its corruption is suspected, the first certification token CNT1 is hacked or its hacking is suspected, and so on.

In a step F2, the certificate creation module 12 suspends the first certification token CNT1 and the corresponding first certificate CERT1_CPE.

In a step F3 carried out before, after or concomitantly with step F2, the certificate creation module 12 generates a second certificate CERT2_CPE associated with the item of equipment 10.

If the second certificate CERT2_CPE is a standard certificate, the latter is generated from the following information: the public key PUB_KEY_CPE of the item of equipment 10, the hash HASH_CPE of a physical address of the item of equipment 10, a certificate CertDHCP associated with the configuration server 11, at least one network address IP_CPE allocated to said item of equipment 10 by the configuration server 11 during step E4 (or a pool of network addresses POOL_IP_CPE allocated to the item of equipment 10), and finally the parameter TYP_HASH on how the hash HASH_CPE is calculated.

If the certificate CERT2_CPE is a restricted-access or “black hole” certificate, it is generated from information unrelated to the item of equipment 10 in order to isolate it.

Whatever the type of certificate generated, the certificate creation module 12 also generates a certification token CNT2 or CNTbh corresponding to the certificate CERT2_CPE associated with the item of equipment 10. Such a certification token device CNT2, CNTbh is a compact form of the certificate CERT2_CPE associated with the item of equipment 10.

It is this certification token device CNT2, CNTbh that will be used by the item of equipment 10 in all cases where the latter needs to provide authentication material to access a service.

To do this, the creation module 12 transmits, during a step F4, the second certification token CNT2, CNTbh to the configuration server 11 so that the latter replaces the first certification token CNT1 associated with the item of equipment 10 with the second certification token CNT2, CNTbh.

In a particular implementation, the reception by the configuration server 11 of the second certification token CNTbh triggers, in a step F5, the allocation of a new network address, known as the “black hole” address, to the item of equipment 10. The use of such a “black hole” address in exchanges from or to the item of equipment 10 makes it possible to isolate the data exchanged by the item of equipment 10 with other items of equipment and in particular the server of a service provider 14. More specifically, the data transmitted from or to the item of equipment 10 by means of this “black hole” address may, in a first case, not be delivered or, in a second case, be routed to a dedicated item of equipment for them to be studied in order to confirm the corruption of the item of equipment 10.

In parallel to the execution of step F4, the creation module 12 transmits, in a step F6, a request to replace DRemp the certificate CERT1_CPE associated with the item of equipment 10 with the domain name “CNT.example.com” by the second certificate CERT2_CPE to the domain name server 13.

Such a replacement request DRemp includes: the first certification token CNT1, the first certificate CERT1_CPE, the second certification token CNT2, CNTbh, the second certificate CERT2_CPE and the public key PUB_KEY_CM of the certificate creation module 12.

At the same time, the creation module 12 stores in a database that the first certificate CERT1_CPE and the first corresponding certification token CNT1 are suspended and replaced by the second certificate CERT2_CPE and the second certification token CNT2, referred to as corresponding CNTbh.

In a step F7, the domain name server 13 extracts all the information included in the replacement request DRemp, suspends the association of the first certificate CERT1_CPE and the corresponding first certification token CNT1 with the domain name “CNT.example.com” and proceeds with the association of the domain name “CNT.example.com” with the second certificate CERT2_CPE and the corresponding second certification token CNT2, CNTbh.

In a step F8, which may be implemented before, after or at the same time as steps F6 and F7, the configuration server 11 transmits a message DHCP ACK to the item of equipment 10. Such a message DHCP ACK includes the second certification token CNT2, CNTbh. As the message DHCP ACK includes the second certification token CNT2, CNTbh, the item of equipment 10 understands that it is no longer authorised to use the first certification token CNT1 and that it must replace it with the second certification token CNT2, CNTbh. If step F5 was implemented by the configuration server 11, then the message DHCP ACK also includes the “black hole” address.

At the end of step F8, the item of equipment 10 wishing to establish a connection with the server of a service provider 14, because the connection established at the end of step G6 was interrupted, transmits to the latter a client Hello message including the certification token CNT2, CNTbh in a step F9.

Upon receipt of this Hello TLS client message, the server of a service provider 14 transmits a message of the DNS Query type including the certification token device CNT2, CNTbh to the domain name server 13 in a step F10.

The domain name server 13 then checks, during a step F11, the validity of the certification token CNT2, CNTbh and sends back, during a step F12, a message indicating that the certification token CNT2, CNTbh is valid but that it offers restricted access to the resources of the server of a service provider 14.

The server of a service provider 14 then transmits, in a step F13, a Server Hello message to the item of equipment 10 indicating that the certificate associated with the item of equipment 10 is valid and indicating that access to its resources is restricted, thus establishing a connection with the item of equipment 10.

In another implementation, the connection established between the item of equipment 10 and the server of a service provider 14 at the end of step G6 being still in use, the reception by the server of a service provider 14, during a step F14, of a message transmitted by the item of equipment 10 and comprising the second certification token CNT2, CNTbh, triggers the transmission, in a step F15, of a message of the DNS Query type comprising the certification token CNT2, CNTbh to the domain name server 13.

The domain name server 13 then checks, during a step F16, the validity of the certification token CNT2, CNTbh and sends back, during a step F17, a message indicating that the certification token CNT2, CNTbh is valid but that it offers restricted access to the resources of the server of a service provider 14.

The server of a service provider 14 then continues to exchange data with the item of equipment 10 in compliance with the access limitations applied to the resources of the server of a service provider 14 associated with the second certification token CNT2, CNTbh during a step F18. The scope of the restriction may be qualitative or quantitative.

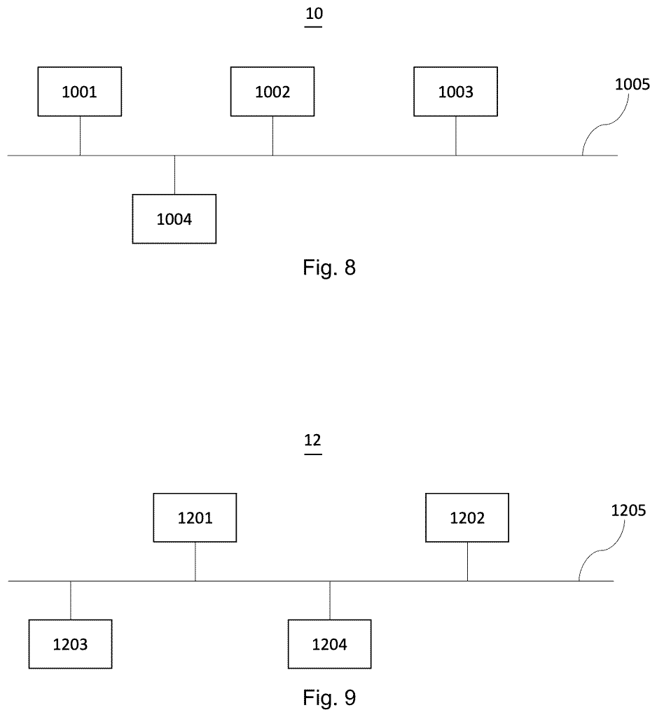

FIG. 8 shows an item of equipment 10 capable of implementing the method for the authenticated establishment of a connection between an item of equipment connected to at least one communication network and a server of a service that is the subject of the present development.

An item of equipment 10 may comprise at least one hardware processor 1001, a storage unit 1002 and an interface 1003, and at least one network interface 1004 which are connected to each other via a bus 1005. Naturally, the components of the item of equipment 10 can be connected by means of a connection other than a bus.

The processor 1001 controls the operations of the item of equipment 10. The storage unit 1002 stores at least one program for implementing the various methods that are the subject of the development to be executed by the processor 1001, and various data, such as parameters used for calculations performed by the processor 1001, intermediate data for calculations performed by the processor 1001, etc. The processor 1001 may be formed by any known and appropriate hardware or software, or by a combination of hardware and software. For example, the processor 1001 can be formed by a dedicated hardware such as a processing circuit, or by a programmable processing unit such as a Central Processing Unit which executes a program stored in a memory thereof.

The storage unit 1002 may be formed by any appropriate means capable of storing the program or programs and data in a computer-readable manner. Examples of storage devices 1002 include non-transitory computer-readable storage media such as semiconductor memory devices, and magnetic, optical or magneto-optical recording media loaded into a read/write device.

The interface 1003 provides an interface between the item of equipment 10 and a network address configuration 11 server.

As for the network interface 1004, it provides a connection between the item of equipment 10 and at least one server of a service provider with which it wants to establish a connection in an authenticated manner.

FIG. 9 shows a creation module 12 capable of implementing the various methods that are the subject of the present development.

A creation module 12 may comprise at least one hardware processor 1201, a storage unit 1202, an interface 1203, and at least one network interface 1204 which are connected to each other via a bus 1205. Naturally, the components of the creation module 12 can be connected by means of a connection other than a bus. In one example, the certificate creation module 12 is embedded in the configuration server 11.

The processor 1201 controls the operations of the creation module 12. The storage unit 1202 stores at least one program for implementing the various methods that are the subject of the development to be executed by the processor 1201, and various data, such as parameters used for calculations performed by the processor 1201, intermediate data for calculations performed by the processor 1201, etc. The processor 1201 may be formed by any known and appropriate hardware or software, or by a combination of hardware and software. For example, the processor 1201 can be formed by a dedicated hardware such as a processing circuit, or by a programmable processing unit such as a Central Processing Unit which executes a program stored in a memory thereof.

The storage unit 1202 may be formed by any appropriate means capable of storing the program or programs and data in a computer-readable manner. Examples of storage devices 1202 include non-transitory computer-readable storage media such as semiconductor memory devices, and magnetic, optical or magneto-optical recording media loaded into a read/write device.

The interface 1203 provides an interface between the creation module 12 and at least one item of equipment 10 wanting to connect to a communication network.

As for the network interface 1204, it provides a connection between the creation module 12 and a domain name server 13.

1. A method for suspending a first certification token corresponding to a first certificate (CERT1_CPE), the first certification token for authenticating the establishment of a connection between an item of equipment connected to at least one communication network and at least one server of a service provider, the first certification token and the first certificate being generated from a hash of a physical address of the item of equipment, a certificate (CertDHCP) associated with a network address configuration server and at least one network address allocated to the item of equipment by the network address configuration server, the method comprising the following implemented by a certificate creation module:
suspending the first certification token triggered by obtaining an item of information relating to a condition for suspending the first certification token, and
transmitting, to a domain name server, a request for suspending an association established between, on one hand, the first certificate and the first certification token and, on the other hand, at least one domain name.

2. The method for suspending a certification token according to claim 1, further comprising:
cancelling the suspension of the first certification token triggered by obtaining an item of information indicating that the condition for suspending the first certification token is no longer satisfied, and
transmitting, to the domain name server, a request for cancelling the suspension of the association established between the first certificate, the first certification token and the at least one domain name.

3. The method for suspending a certification token according to claim 1, further comprising the following when the condition of suspending the first certification token is accompanied by a request to replace the first certification token:
generating a second certificate (CERT2_CPE) associated with the item of equipment and a corresponding second certification token,
transmitting, to the domain name server, a request to associate, on one hand, the second certificate and the second certification token with, on the other hand, the domain name previously associated with the first certificate and the corresponding first certification token, and
transmitting the second certification token to the item of equipment.

4. The method for suspending a certification token according to claim 3, wherein the second certification token offers restricted access to the resources of the server of a service provider.

5. The method for suspending a certification token according to claim 1, further comprising transmitting, to the network address configuration server, a request to provide, to the equipment, at least one network address pointing to a host machine acting as a fictitious server of the provider.

6. The method for suspending a certification token according to claim 1, wherein the condition for suspending the first certification token belongs to a group comprising:
a request for suspending the first certification token, the suspension request being issued by the item of equipment,
a request for suspending the first certification token, the suspension request being issued by an item of equipment of the network,
an expiration of an allocation time of the network address allocated to the item of equipment,
an expiration of a lifetime of the first certification token,
a use conflict in an addressing plan,
an item of information relating to a compromise of the first certification token, and
an item of information relating to a hacking of the first certification token.

7. A certificate creation module adapted to suspend a first certification token corresponding to a first certificate (CERT1_CPE), the first certification token for authenticating the establishment of a connection between an item of equipment connected to at least one communication network and at least one server of a service provider, the first certification token and the first certificate being generated by the certificate creation module from a hash of a physical address of the item of equipment, a certificate (CertDHCP) associated with a network address configuration server and at least one network address allocated to the item of equipment by the network address configuration server, the certificate creation module comprising at least one processor configured to:
suspend the first certification token after obtaining an item of information relating to a condition for suspending the first certification token, and
transmit, to a domain name server, a request for suspending an association established between, on one hand, the first certificate and the first certification token and, on the other hand, at least one domain name.

8. A network address configuration server comprising at least one certificate creation module adapted to suspend a first certification token corresponding to a first certificate (CERT1_CPE), the first certification token for authenticating the establishment of a connection between an item of equipment connected to at least one communication network and at least one server of a service provider, the first certification token and the first certificate being generated by the certificate creation module from a hash of a physical address of the item of equipment, a certificate (CertDHCP) associated with the network address configuration server and at least one network address allocated to the item of equipment by the network address configuration server, the certificate creation module comprising at least one processor configured to:
suspend the first certification token after obtaining an item of information relating to a condition for suspending the first certification token, and
transmit, to a domain name server, a request for suspending an association established between, on one hand, the first certificate and the first certification token and, on the other hand, at least one domain name.

9. A processing circuit comprising a processor and a memory, the memory storing program code instructions of a computer program to execute the method for suspending a first certification token according to claim 1, when the computer program is executed by the processor.
